(19) United States
(12) Patent Application Publication
(10) Pub. No.: US 2015/0077312 A1
(43) Pub. Date: Mar. 19, 2015

(54) NEAR-TO-EYE DISPLAY HAVING ADAPTIVE OPTICS

(71) Applicant: Chia-Jean Wang, Palo Alto, CA (US)

(72) Inventor: Chia-Jean Wang, Palo Alto, CA (US)

(73) Assignee: GOOGLE INC., Mountain View, CA (US)

(21) Appl. No.: 13/107,812

(22) Filed: May 13, 2011

(51) Int. Cl. G09G 5/00; G02B 27/01

(52) U.S. Cl. 345/7; 359/631

(57) ABSTRACT

An optical apparatus includes a light source, a deformable mirror, an actuator system, and a partially transparent mirror. The deformable mirror is positioned in an optical path of the image output from the light source. The actuator system is coupled to the deformable mirror to selectively adjust at least a curvature of the deformable mirror. The partially transparent mirror is positioned to be in front of the eye of the user when the optical apparatus is worn and optically aligned with the deformable mirror such that the image output from the light source positioned peripherally to the eye is reflected by the deformable mirror to the partially transparent mirror and reflected by the partially transparent mirror to the eye of the user.

### TECHNICAL FIELD

This disclosure relates generally to the field of optics, and in particular but not exclusively, relates to near-to-eye optical systems.

### BACKGROUND INFORMATION

A head mounted display (“HMD”) is a display device worn on or about the head. HMDs usually incorporate some sort of near-to-eye optical system to display an image within a few centimeters of the human eye. Single eye displays are referred to as monocular HMDs while dual eye displays are referred to as binocular HMDs. Some HMDs display only a computer generated image (“CGI”), while other types of HMDs are capable of superimposing CGI over a real-world view. This latter type of HMD is often referred to as augmented reality because the viewer's image of the world is augmented with an overlaying CGI, also referred to as a heads-up display (“HUD”).

HMDs have numerous practical and leisure applications. Aerospace applications permit a pilot to see vital flight control information without taking their eye off the flight path. Public safety applications include tactical displays of maps and thermal imaging. Other application fields include video games, transportation, and telecommunications. There is certain to be new found practical and leisure applications as the technology evolves; however, many of these applications are currently limited due to the cost, size, field of view, eye box, and efficiency of conventional optical systems used to implemented existing HMDs.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1A illustrates a first conventional near-to-eye optical system using an input lens and two mirrors.

FIG. 1B illustrates a second conventional near-to-eye optical system using angle sensitive dichroic mirrors.

FIG. 1C illustrates a third conventional near-to-eye optical system using holographic diffraction gratings.

FIG. 2 illustrates a near-to-eye optical apparatus having adaptive optics, in accordance with an embodiment of the disclosure.

FIG. 3A is a side view illustration of a deformable mirror and an actuator system for adjusting a curvature of the deformable mirror and adjusting a global orientation of the deformable mirror, in accordance with an embodiment of the disclosure.

FIG. 3B is a plan view illustration of the deformable mirror and the actuator system, in accordance with an embodiment of the disclosure.

FIG. 4 illustrates a near-to-eye optical apparatus including a gaze tracking feedback system to improve the field of view and/or the eye box, in accordance with an embodiment of the disclosure.

FIG. 5 is a functional block diagram illustrating a control system for the near-to-eye optical apparatus including the gaze tracking feedback system, in accordance with an embodiment of the disclosure.

FIG. 6 is a flow chart illustrating a process for operating a near-to-eye optical apparatus including a gaze tracking feedback system to improve the field of view and/or the eye box, in accordance with an embodiment of the disclosure.

FIG. 7 is a top view of a near-to-eye imaging system using adaptive optics, in accordance with an embodiment of the disclosure.

### DETAILED DESCRIPTION

Embodiments of an apparatus and system for a near-to-eye display having adaptive optics are described herein. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

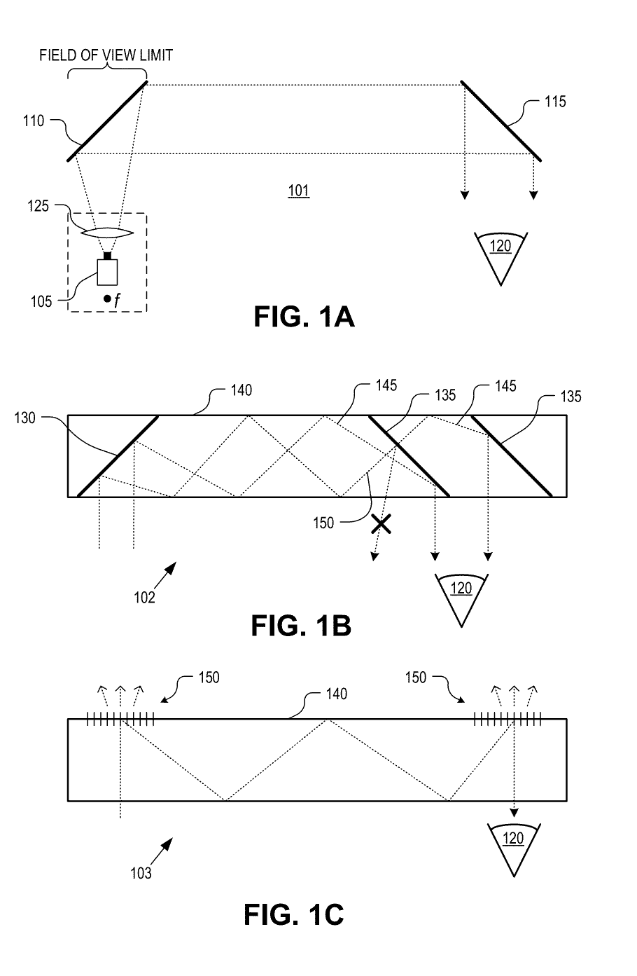

FIG. 1A illustrates a first conventional near-to-eye optical system 101 using an input lens and two mirrors. An image source 105 outputs an image that is reflected by two mirrors 110 and 115, which form an image near to eye 120. Image source 105 is typically mounted above the head or to the side of the head, while mirrors 110 and 115 bend the image around the front of the viewer's face to their eye 120. Since the human eye is typically incapable of focusing on objects placed within a few centimeters, this system requires a lens 125 interposed between the first mirror 110 and image source 105. Lens 125 creates a virtual image that is displaced further back from the eye than the actual location of mirror 115 by positioning image source 105 inside of the focal point f of lens 125. Optical system 101 suffers from a relatively small field of view (e.g., approximately 20 degrees) limited by the extent of mirrors 110 and 115 and the bulkiness of lens 125. The field of view can be marginally improved by placing mirrors 110 and 115 within a high index material to compress the angles of incidence, but is still very limited and the thickness of the waveguide rapidly increases to achieve larger fields of view.

FIG. 1B illustrates a second conventional near-to-eye optical system 102 using angle sensitive dichroic mirrors. Optical system 102 includes a single in-coupling mirror 130 and two out-coupling dichroic mirrors 135 disposed within a waveguide 140. This system uses collimated input light from virtual images placed at infinity. In order to produce a useful image at eye 120, each incident angle of input light should correspond to a single output angle of emitted light. Since light can potentially reflect off of output mirrors 135 on either a downward trajectory (ray segments 145) or an upward trajectory (ray segments 150), each input angle can potentially result in multiple output angles, thereby destroying the output image. To overcome this problem, optical system 102 uses angle sensitive dichroic mirrors 135 that pass light incident sufficiently close to normal while reflecting light having a sufficiently oblique incidence. However, the nature of dichroic mirrors 135 that passes some incident angles while reflecting others limits the field of view optical system 102 and the dichroic mirror coating does not provide sharp angular cutoffs, resulting in ghosting effects.

FIG. 1C illustrates a third conventional near-to-eye optical system 103 using holographic diffraction gratings. Optical system 103 is similar to optical system 102, but uses holographic diffraction gratings 150 in place of mirrors 130 and 135. Diffraction gratings 150 are inefficient reflectors, since they only reflect higher order diffractions while passing the first order diffraction, which contains the largest portion of energy in an optical wave front. In addition to being poor optical reflectors, the input and output diffraction gratings must be precisely tuned to one another, else the output image will suffer from color separation. Achieving a sufficient match between the input and output gratings 150 requires extreme control over manufacturing tolerances, which is often difficult and costly. Again, optical system 103 suffers from a limited field of view.

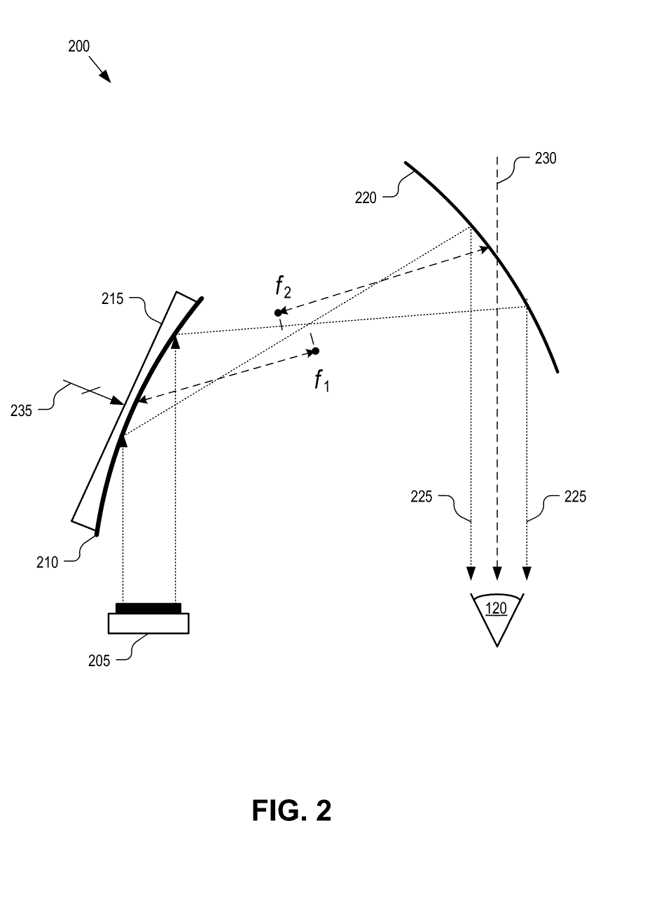

FIG. 2 illustrates a near-to-eye optical system 200 implemented with adaptive optics, in accordance with an embodiment of the disclosure. The illustrated embodiment of system 200 includes a light source 205, a deformable mirror 210, an actuator system 215, and a partially transparent mirror 220. System 200 can be arranged into a head mounted display (“HMD”) to display a near-to-eye image 225 to eye 120 that augments an external scene image 230 to provide an augmented reality heads up display.

Light source 205 is typically located peripheral to eye 120 and deformable mirror 210 and partially transparent mirror 220 provided in the output optical path to transport image 225 to a location in front of eye 120. Light source 205 may be implemented with a variety of optical engines, such as an organic light emitting diode (“OLED”) source, an active matrix liquid crystal display (“AMLCD”) source, a laser source, or otherwise. In one embodiment, the light output by light source 205 is substantially collimated. In other embodiments, the light output by light source 205 need not be collimated.

Deformable mirror 210 is a concave mirror surface physically coupled to actuator system 215 to be physically manipulated to change the location of its adjustable focal point f1. Actuator system 215 is responsive to one or more control signals 235 to selectively control the manipulation of deformable mirror 210. In one embodiment, actuator system 215 is capable of dynamically changing a virtual zoom associated with deformable mirror 210 by adjusting one or more localized slope regions within deformable mirror 210. In one embodiment, actuator system 215 is further capable of dynamically changing a global orientation of deformable mirror 210 about one or two rotational axes or even one or two translational axes. Deformable mirror 210 may be implemented as a flexible reflective film (e.g., silver-coated membrane) disposed over an adjustable surface of actuator system 215.

In one embodiment, partially transparent mirror 220 is a concave reflective surface having a fixed focal point f2. Partially transparent mirror 220 is at least partially reflective to image 225 output from light source 205 while being at least partially transparent to external scene light 230. Partially transparent mirror 220 may be implemented as a glass or plastic substrate having an index of refraction different from air. For example, partially transparent mirror 220 may be an eyeglass lens. In one embodiment, light source 205 may generate light in a specific wavelength band and partially transparent mirror 220 may be coated with a multi-layer dichroic film to reflect the specific wavelength band output by light source 205 while passing other wavelengths outside the band to permit external scene light 230 to pass through to eye 120. In yet another embodiment, partially transparent mirror 220 is a complex optical surface with an internally embedded or surface mounted array of micro-mirrors that reflect image 225 while external scene light 230 passes between the individual micro-mirrors.

During operation, focal point f1 of deformable mirror 210 may be dynamically adjusted or moved by actuator system 215 in response to control signals 235. Focal point f1 may be moved anywhere within a focal distance f2 of partially transparent mirror 220. Thus, f1 may overlap or coincide with f2, or be translated towards partially transparent mirror 220 to fall somewhere between f2 and the surface of partially transparent mirror 220. By placing f1 equal to or inside of f2, image 225 is virtually displaced back from eye 120 making it possible for a human eye to bring image 225 into focus in a near-to-eye HMD configuration. By translating f1 to f2 distance away from partially transparent mirror 220, image 225 is virtually positioned at or near infinity. In this manner, a dynamic virtual zoom of image 225 may be electromechanically implemented enabling image 225 to be enlarged or reduced in size under dynamic control.

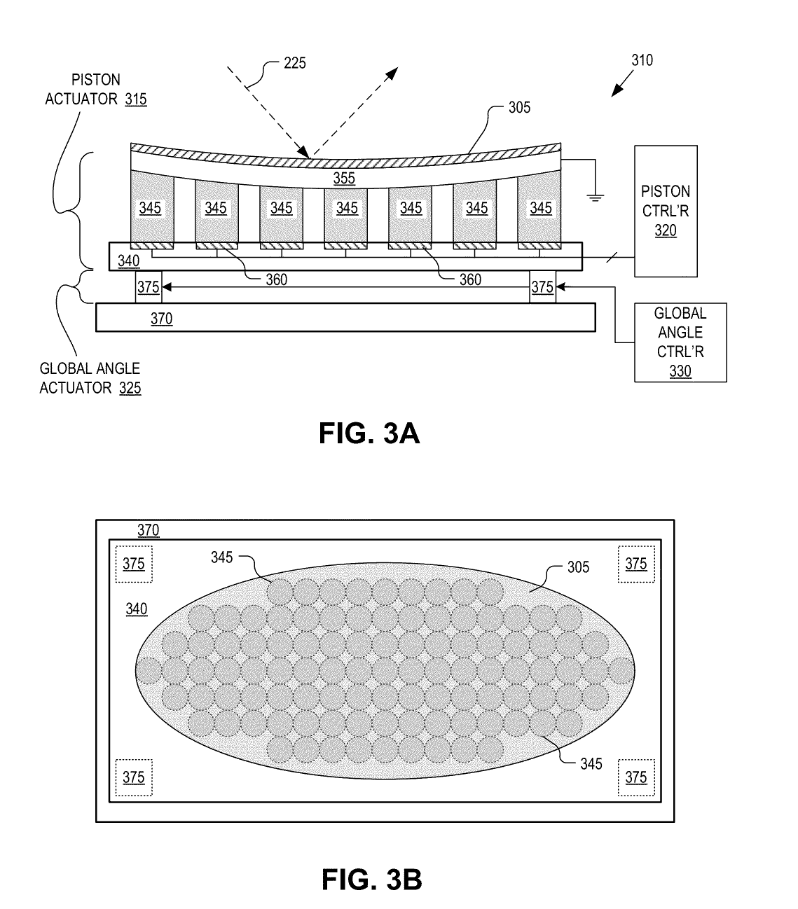

FIGS. 3A and 3B illustrate a deformable mirror 305 and actuator system 310, in accordance with an embodiment of the disclosure. FIG. 3A is a hybrid side view and block diagram of deformable mirror 305 and actuator system 310, while FIG. 3B is a plan view of the same. Deformable mirror 305 and actuator system 310 represent one possible implementation of deformable mirror 210 and actuator system 215 illustrated in FIG. 2. The illustrated embodiment of actuator system 310 includes a piston actuator 315, a piston controller 320, a global angle actuator 325, and a global angle controller 330. Although not illustrated, actuator system 310 may further, or alternatively, include a global translation actuator to translate deformable mirror 210 along one or more translation dimensions.

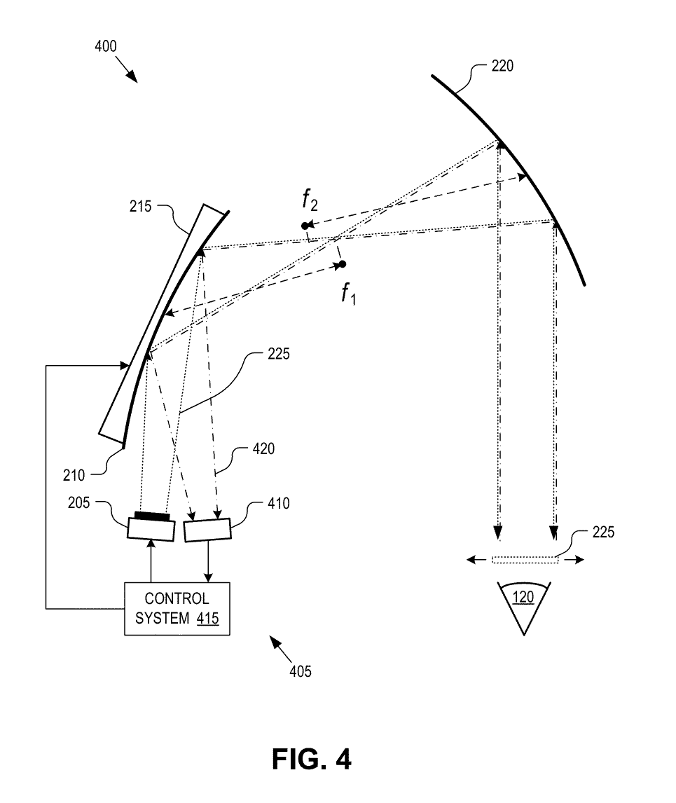

The illustrated embodiment of piston actuator 315 includes a platform 340, an array of electrostatically activated pistons 345, a ground plane 355, and electrodes 360. In one embodiment, electrostatically activated pistons 345 are piezo-electric material (e.g., crystal, ceramic, etc.) that can be made to expand or contract in response to an applied electric bias signal applied across the material. In one embodiment, electrostatically activated pistons 345 are microelectromechanical systems (“MEMS”) that adjust their vertical displacement in response to an applied electrical signal. The individual pistons 345 may be made of varying heights across the array such that their un-actuated default height form a concave surface that approximates the desired curvature of deformable mirror 305. In the illustrated embodiment, a ground plane 355 overlays the upper distal ends of pistons 345 and is in electrical and physical contact with each piston 345. Ground plane 355 can be biased to a fixed potential (e.g., ground) and the individual activation signals applied to selected pistons 345 via electrodes 360 disposed in or on platform 340 under control of piston controller 320. In other embodiments, ground plane 355 may be substituted for individual electrodes coupled to the sides or distal ends of pistons 345. Deformable mirror 305 overlays the upper distal ends of pistons 345 above ground plane 355. Thus, when individual pistons 345 are activated, they are selectively displaced from their relaxed position, resulting in adjustments to the curvature of deformable mirror 305. These adjustments can be made as biasing adjustments to achieve a fixed curvature or continuously made in real-time to dynamically adjust the curvature during operation. Dynamic adjustments can be used to implement a dynamic virtual zoom or track eye movements to improve a field of view and/or eyebox of a HMD (discussed in greater detail below in connection with FIGS. 4-6).

Global angle actuator 325 may be used to adjust the overall orientation (e.g., global angle) of deformable mirror 305. Global angle actuator 325 couples to the platform 340 to rotate platform 340 along one or two axes and is itself disposed on a substrate 370. Global angle actuator 325 may be implemented using a variety of different electromechanical actuators, such as servo devices, MEMS devices, an electrostatically activated gimbal mount, or otherwise. The illustrated embodiment includes four electrostatically activated pistons 375 that can each be independently height adjusted, under control of global angle controller 330, to achieve a tip or tilt rotation along two rotational axes. Alternatively, pistons 375 may be implemented as micro-springs and electrostatic plates used to compress or expand the springs to achieve a desired rotational orientation. It should be appreciated that a variety of techniques may be used to implement global angle actuator 325.

FIG. 4 illustrates a near-to-eye optical system 400 implemented with adaptive optics and gaze tracking feedback to improve the field of view and/or the eye box of an HMD incorporating system 400, in accordance with an embodiment of the disclosure. The illustrated embodiment of system 400 includes light source 205, deformable mirror 210, actuator system 215, partially transparent mirror 220, and gaze tracking system 405. The illustrated embodiment of gaze tracking system 405 includes a gaze tracking camera 410 and a control system 415.

Gaze tracking system 405 is provided to continuously monitor the movement of eye 120, to determine a gazing direction (e.g., location of the pupil) of eye 120 in real-time, and to provide feedback signals to the adaptive optics (e.g., actuator system 215 and light source 205). The real-time feedback control can be used to dynamically adjust the position, orientation, and/or curvature of deformable mirror 210 so that image 225 can be translated or virtually zoomed to track the movement of eye 120. Furthermore, the feedback control can be used to adjust pre-distortion applied to image 225 to compensate for the dynamic adjustments applied to deformable mirror 210. Via appropriate feedback control, image 225 can be made to move with eye 120 in a complementary manner to increase the size of the eye box and/or the field of view of image 225 displayed to eye 120. For example, if eye 120 looks left, then image 225 may be shifted to the left to track the eye movement and remain in the user's central vision. Gaze tracking system 405 may also be configured to implement other various function as well. For example, gaze tracking system 405 may be used to implement a user interface controlled by eye motions that enable to the user to select objects within their vision and issue other commands.

In the illustrated embodiment, gaze tracking camera 410 is positioned to acquire eye images 420 via reflection off of deformable mirror 210 and partially transparent mirror 220. However, in other embodiments, gaze tracking camera 410 can be positioned to acquire a direct image of eye 120 without any reflective surfaces, can be positioned to acquire a reflected image of eye 120 using only partially transparent mirror 220, or can use one or more independent mirrors (not illustrated).

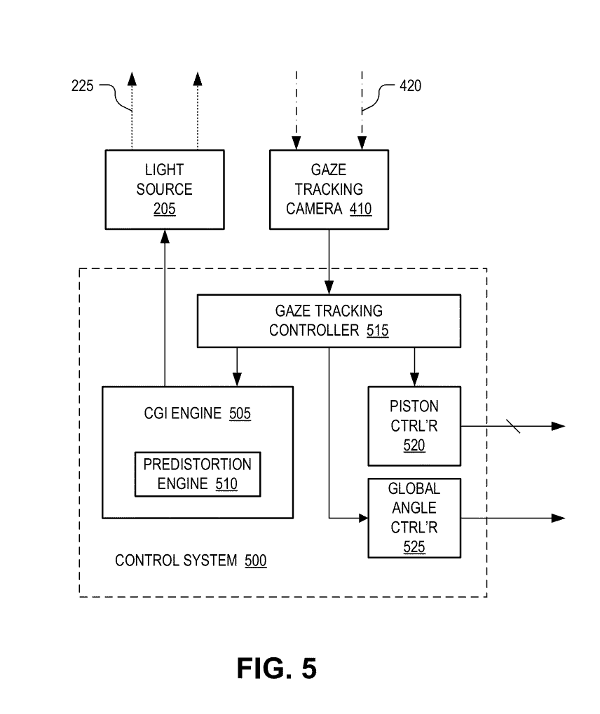

FIG. 5 is a functional block diagram illustrating a control system 500 for a near-to-eye optical apparatus including a gaze tracking feedback system, in accordance with an embodiment of the disclosure. Control system 500 represents one possible implementation of control system 415 illustrated in FIG. 4. The illustrated embodiment of control system 500 includes a computer generated image (“CGI”) engine 505 including a pre-distortion engine 510, a gaze tracking controller 515, a piston controller 520, and a global angle controller 525. The functionality provide by control system 500, and its individual components, may be implemented entirely in hardware (e.g., application specific integrated circuit, field programmable gate array, etc.), entirely in firmware/software executing on a general purpose processor, or a combination of both.

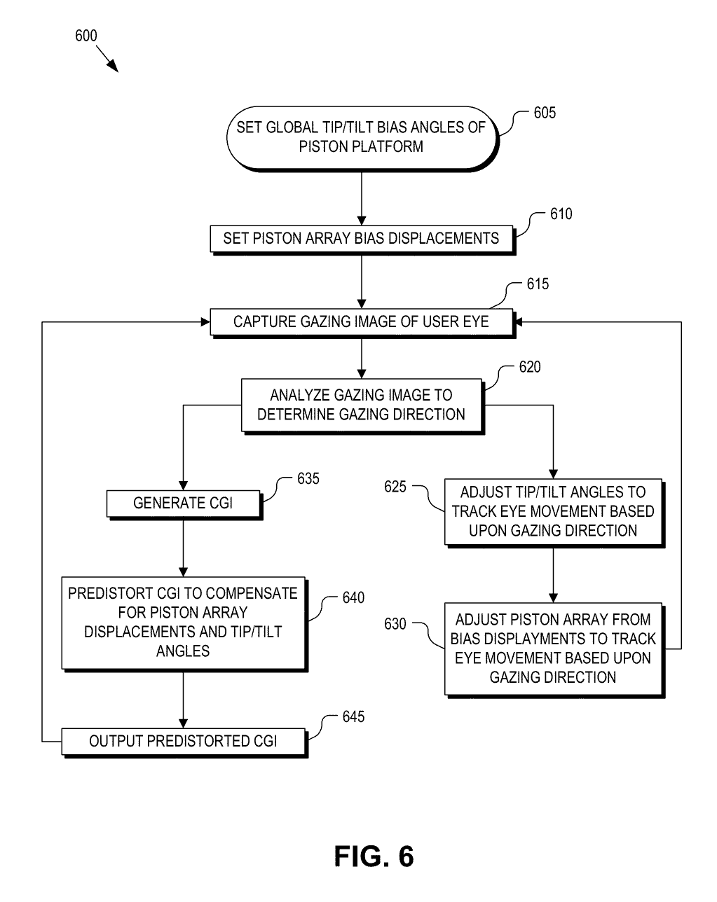

FIG. 6 is a flow chart illustrating a process 600 of operation of control system 500, in accordance with an embodiment of the disclosure. The order in which some or all of the process blocks appear in process 600 should not be deemed limiting. Rather, one of ordinary skill in the art having the benefit of the present disclosure will understand that some of the process blocks may be executed in a variety of orders not illustrated or even in parallel.

In a process block 605, the global tip/tilt rotational bias angles of piston platform 340 are set. The global bias angles are set under control of global angle controller 525. In one embodiment, the bias angles simply correspond to a predetermined configuration setting. In one embodiment, the bias angles may be calibrated on a per user basis and may even be calibrated each time the user wears the HMD to account for different face widths and eye separation distances. If the actuator system includes a global translational actuator sub-system, then it may be biased in process block 605.

In a process block 610, the bias displacements for the array of pistons 345 are set. The bias displacements are set under control of piston controller 520 and affect the curvature of deformable mirror 210. In one embodiment, the bias displacements may be set to a predetermined setting based upon a particular user, a particular CGI application, or both. For example, different CGI applications may call for different virtual zoom settings, which can be set via the bias displacement. Similarly, each user may configure control system 500 to set the virtual zoom associated with the CGI (e.g., image 225) to a user selected default setting.

In a process block 615, gaze tracking camera 410 captures gazing image 420 of eye 120. Gazing image 420 may be acquired as a direct image or a reflection off of one or more reflective surfaces. A new gazing image 420 may be continually acquired as a video stream of images. In a process block 620, gazing image 420 is analyzed by gaze tracking controller 515 to determine the current gazing direction of eye 120. The gazing direction may be determined based upon the location of the pupil within the gazing image 420. With the real-time gazing direction determined, gaze tracking controller 515 can provide feedback control signals to global angle controller 525 and piston controller 520 to adjust their bias setting in real-time and further provide a feedback control signal to CGI engine 505 to facilitate real-time pre-distortion correction to compensate for the adjustments applied to deformable mirror 210.

In a process block 625, global angle controller 525 adjusts the global bias angles of platform 340, thereby adaptively redirecting image rays into a moving eye. The location of image 225 can be translated vertically or horizontally via appropriate angle manipulation of platform 340 under control of global angle controller 525. In one embodiment, global angle controller 525 may provide coarse position control. In another embodiment (not illustrated), a global translation controller may translate the location of deformable mirror 210 to also achieve adaptive redirecting of image rays into the moving eye.

In a process block 630, piston controller 520 adjusts the bias displacements of the array of pistons 345. While piston displacement may typically be used for dynamic zoom control, it may also be used to impart fine tuning for eye tracking purposes by adaptively redirecting image rays into a moving eye. For example, the location of image 225 can be translated vertically or horizontally by shifting the minimum point of the concave deformable mirror 210. However, in some embodiment, piston displacement may be exclusively used for virtual zoom while global angle control is used for eye tracking to improve eye box and/or field of view using dynamic image adjustments.

As gaze tracking controller 515 provides feedback control to piston controller 520 and/or global angle controller 525, adjustments made by these subsystems cause dynamically changing optical distortion. Accordingly, gaze tracking controller 515 may provide feedback control to CGI engine 505 and pre-distortion engine 510 to compensate. In a process block 635, an undistorted CGI image is computed or generated. This undistorted CGI image may then be pre-distorted by pre-distortion engine 510 to compensate for the optical distortion imparted by deformable mirror 210 and partially transparent mirror 220. Since deformable mirror 210 may be dynamically manipulated, the optical distortion imparted by this mirror is dynamic. Accordingly, pre-distortion engine 510 uses the feedback control signal provided by gaze tracking controller 515 to apply the appropriate pre-distortion based upon the current setting applied by piston controller 520 and global angle controller 525. Pre-distortion may include applying various types of complementary optical correction effects including keystone, barrel, and pincushion. Finally, in a process block 645, the pre-distorted CGI is output from light source 205 as image 225 under control of CGI engine 505.

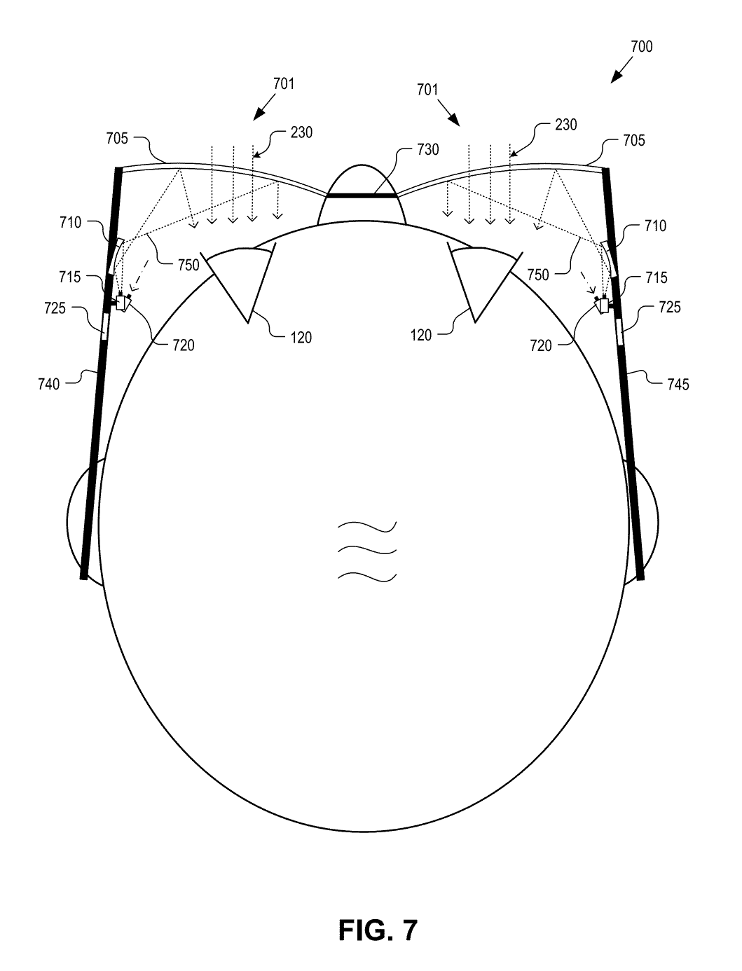

FIG. 7 is a top view of a HMD 700 using a pair of near-to-eye optical systems 701, in accordance with an embodiment of the disclosure. Each near-to-eye optical system 701 may be implemented with near-to-eye optical system 200, near-to-eye optical system 400, or various combinations thereof. The illustrated embodiment of HMD 700 includes partially transparent mirrors 705, deformable mirrors 710, light source 715, gaze tracking camera 720, and a control system 725 all mounted to a frame assembly. The illustrated embodiment of the frame assembly includes a nose bridge 730, left ear arm 740, and right ear arm 745. Partially transparent mirrors 705 have been fabricated into eyeglass lenses supported by the frame assembly.

The two near-to-eye optical systems 701 are secured into an eye glass arrangement that can be worn on the head of a user. The left and right ear arms 740 and 745 rest over the user's ears while nose assembly 730 rests over the user's nose. The frame assembly is shaped and sized to position each partially transparent mirror 705 in front of a corresponding eye 120 of the user. Of course, other frame assemblies may be used (e.g., single, contiguous visor for both eyes, integrated headband or goggles type eyewear, etc.).

The illustrated embodiment of HMD 700 is capable of displaying an augmented reality to the user. Partially transparent mirrors 705 permit the user to see a real world image via external scene light 230. Left and right (binocular embodiment) CGIs 750 may be generated by one or two image processors (not illustrated) coupled to a respective light source 715. Although the human eye is typically incapable of bringing objects within a few centimeters into focus, the focal points of deformable mirrors 710 are positioned relative to the focal points of partially transparent mirrors 705 to bring the image into focus by virtually displacing CGI 750 further back from eyes 120. CGIs 750 are seen by the user as virtual images superimposed over the real world as an augmented reality. Furthermore, the adaptive nature of optics can be used to provide real-time, dynamic virtual zoom to adjust the size of CGI 750 and to provide eye tracking with the output image rays to improve the field of view and/or eye box.

The processes explained above are described in terms of computer software and hardware. The techniques described may constitute machine-executable instructions embodied within a tangible machine (e.g., computer) readable storage medium, that when executed by a machine will cause the machine to perform the operations described. Additionally, the processes may be embodied within hardware, such as an application specific integrated circuit (“ASIC”) or the like.

A tangible machine-readable storage medium includes any mechanism that provides (i.e., stores) information in a form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

1. An optical apparatus, comprising:
an light source to output an image for display to an eye of a user;
a single continuous deformable mirror surface positioned in an optical path of the image output from the light source;
an actuator system coupled to the single continuous deformable mirror surface to selectively adjust at least a curvature of the single continuous deformable mirror surface;
a partially transparent mirror positioned to be in front of the eye of the user when the optical apparatus is worn and optically aligned with the single continuous deformable mirror surface such that the image output from the light source positioned peripherally to the eye is reflected by the single continuous deformable mirror surface to the partially transparent mirror and reflected by the partially transparent mirror to the eye of the user; and
a computer generated image (“CGI”) engine including a pre-distortion engine, the CGI engine coupled to drive the light source with the image being pre-distorted to dynamically compensate for optical distortion due to real-time adjustments in the curvature of the single continuous deformable mirror made in response to eye movements.

2. The optical apparatus of claim 1, wherein the single continuous deformable mirror surface and the partially transparent mirror are positioned relative to each other such that a focal point of the single continuous deformable mirror surface falls at or within a focal distance of the partially transparent mirror from the partially transparent mirror.

3. The optical apparatus of claim 2, wherein the single continuous deformable mirror surface comprises a reflective membrane.

4. The optical apparatus of claim 3, wherein the first actuator system comprises:
a platform; and
an array of pistons disposed across the platform, wherein the reflective membrane is disposed across distal ends of the pistons such that height adjustments to individual pistons change the curvature of the single continuous deformable mirror surface.

5. The optical apparatus of claim 4, wherein the pistons comprise electrostatically activated pistons, the optical apparatus further comprising:
a piston controller coupled to selectively activate individual electrostatically activated pistons to dynamically control the curvature of the single continuous deformable mirror surface.

6. The optical apparatus of claim 5, further comprising:
a gaze tracking camera optically aligned to capture real-time eye images of the eye when the optical apparatus is worn by the user; and
a gaze tracking controller coupled to receive the eye images from the gaze tracking camera, coupled to analyze the eye images to determine a gazing direction, and coupled to the piston controller to provide a feedback control signal to the piston controller to dynamically adjust a position of the image displayed to the eye based upon the gazing direction of the eye.

7. The optical apparatus of claim 6, wherein the pre-distortion engine is coupled to the gaze tracking controller to dynamically adjust pre-distortion applied to the image based upon the gazing direction of the eye.

8. The optical apparatus of claim 4, wherein the global angle actuator system further comprises:
a global angle actuator coupled to the platform to rotate the single continuous deformable mirror surface about at least one axis; and
a global angle controller coupled to dynamically control at least one rotational angle of the single continuous deformable mirror surface.

9. The optical apparatus of claim 8, further comprising:
a gaze tracking camera optically aligned to capture real-time eye images of the eye; and
a gaze tracking controller coupled to receive the eye images from the gaze tracking camera, coupled to analyze the eye images to determine a gazing direction of the eye in real-time, and coupled to the global angle controller to provide a feedback control signal to the global angle controller to adjust the at least one rotational angle of the single continuous deformable mirror surface based upon the gazing direction to dynamically translate a location of the image displayed to the eye to track eye movement.

10. A head mounted display (“HMD”) for displaying an image to a user, the head mounted display comprising:
a near-to-eye optical system including:
an light source to output the image for display to an eye of the user when the HMD is worn by the user;
a single continuous deformable mirror surface positioned in an optical path of the image output from the light source;
an actuator system coupled to the single continuous deformable mirror surface to selectively adjust at least a curvature of the single continuous deformable mirror surface;
a partially transparent eyeglass lens positioned in front of the eye when the HMD is worn and optically aligned with the single continuous deformable mirror surface such that the image output from the light source positioned peripherally to the eye is reflected by the single continuous deformable mirror surface to the eyeglass lens and reflected by the eyeglass lens to the eye; and
a computer generated image (“CGI”) engine including a pre-distortion engine, the CGI engine coupled to drive the light source with the image being pre-distorted to dynamically compensate for optical distortion due to real-time adjustments in the curvature of the single continuous deformable mirror made in response to eye movements; and
a frame assembly to support the near-to-eye optical system for wearing on a head of the user with the eyeglass lens positioned in front of the eye of the user.

11. The HMD of claim 10, wherein the single continuous deformable mirror surface and the eyeglass lens are positioned relative to each other such that a focal point of the single continuous deformable mirror surface falls at or within a focal distance of the eyeglass lens from the eyeglass lens.

12. The HMD of claim 11, wherein the first actuator system comprises:
a platform;
an array of pistons disposed across the platform, wherein the single continuous deformable mirror surface is disposed across distal ends of the pistons such that height adjustments to individual pistons changes the curvature of the single continuous deformable mirror surface, wherein the pistons comprise electrostatically activated pistons; and
a piston controller coupled to selectively activate individual electrostatically activated pistons to dynamically control the curvature of the single continuous deformable mirror surface.

13. The HMD of claim 12, further comprising:
a gaze tracking camera optically aligned to capture real-time eye images of the eye; and
a gaze tracking controller coupled to receive the eye images from the gaze tracking camera, coupled to analyze the eye images to determine a gazing direction, and coupled to the piston controller to provide a feedback control signal to the piston controller to dynamically adjust a position of the image displayed to the eye based upon the gazing direction of the eye.

14. The HMD of claim 13, wherein the pre-distortion engine is coupled to the gaze tracking controller to dynamically adjust pre-distortion applied to the image based upon the gazing direction of the eye.

15. The HMD of claim 12, wherein the global angle actuator system further comprises:
a global angle actuator coupled to the platform to rotate the single continuous deformable mirror surface about at least one axis; and
a global angle controller coupled to dynamically control at least one rotational angle of the single continuous deformable mirror surface.

16. A method of providing an augmented reality with a head mounted display, the method comprising:
generating an image at a peripheral location to an eye of a user;
transporting the image from the peripheral location to be in front of the eye with a single continuous deformable mirror surface and a partially transparent mirror;
adjusting a curvature of the single continuous deformable mirror surface with an array of electrostatically activated pistons upon which the single continuous deformable mirror surface is disposed;
passing external scene light through the partially transparent mirror to the eye of the user such that the image is combined with the external scene light received at the eye;
capturing a gazing image of the user eye while displaying the image to the eye;
analyzing the gazing image to determine a gazing direction in real-time while displaying the image to the eye;
adjusting, in real-time, displacements of the array of electrostatically activated pistons in response to the determined gazing direction to deform the single continuous deformable mirror surface and track eye movement with the image thereby improving a field of view associated with the head mounted display; and
pre-distorting the image to dynamically compensate for image distortion imparted in real-time by the single continuous deformable mirror surface in response to movements of the eye.

17. The method of claim 16, wherein adjusting the curvature of the single continuous deformable mirror surface comprises adjusting the curvature in real-time to provide a virtual zoom to the image during operation of the head mounted display.

18. (canceled)

19. The method of claim 16, further comprising:
adjusting the pre-distorting of the image in real-time to compensate for deformation adjustments to the single continuous deformable mirror surface while tracking the eye movement.

20. The method of claim 16, further comprising:
capturing a gazing image of the user eye while displaying the image to the eye; and
analyzing the gazing image to determine a gazing direction while displaying the image to the eye,
wherein adjusting the global rotational angle of the single continuous deformable mirror surface comprises adjusting the global rotational angle of the single continuous deformable mirror surface in response to the determined gazing direction to translate a position of the image displayed to the eye and to track eye movement with the image.

21. (canceled)

22. The optical apparatus of claim 1, wherein the actuator system includes a first actuator system that adjusts the curvature of the single continuous deformable mirror surface and a global angle actuator system coupled to rotate the single continuous deformable mirror surface about at least one axis without changing the curvature of the single continuous deformable mirror surface.
